(19) United States
(12) Patent Application Publication
(10) Pub. No.: US 2006/0010218 A1
(43) Pub. Date: Jan. 12, 2006

(54) Automatic and confirmed message receipt

(76) Inventor: William E. Turcotte II, Lafayette, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 11/151,737

(22) Filed: Jun. 13, 2005

Related U.S. Application Data
(60) Provisional application No. 60/578,968, filed on Jun. 11, 2004.

(51) Int. Cl. G06F 15/16

(52) U.S. Cl. 709/206

(57) ABSTRACT

Services, systems and methods for managing, streamlining and tracking the communication between administrators and members of an organized group such as sports teams, scouts, church groups, PTA, clubs, business teams, board members and the like. The service is well suited for activities whose events are subject to change on a short notice, but is equally attractive to activities that require a fair amount of communication. Communication with activity members is managed as a combination of email, recorded and dynamically generated telephone messages depending on the urgency of the information.

### RELATED APPLICATIONS

This application claims the benefit of U.S. Provisional Application Ser. No. 60/578,968 filed on Jun. 11, 2004 and incorporated herein by reference.

### BACKGROUND OF THE INVENTION

1. Field of the Invention

The present invention relates, in general, to managing communication within a registered group or activity, and, more particularly, to software, systems and methods that push messages to members of a group, but track delivery of the messages and automatically confirm receipt of the messages. In addition, the present invention relates to systems that integrate calling technology, Instant Messaging, Short Message Service and email in such a way that the sender may escalate message delivery from email to the telephone, or other mode of communication, automatically.

2. Relevant Background

Participants in a wide variety of professional, educational, and recreational organizations rely on planning, scheduling and managing events or activities in which organization members participate. Activity, event management, and information dissemination is a difficult and cumbersome task, the burdens of which often fall disproportionately on a particular few members of an organization. While it is often possible to schedule events and meetings well in advance, circumstances often dictate last-minute changes to the schedules. Managing notifications of schedule changes and other events takes time and energy that could be better spent on professional, instructional, and/or recreational activities.

A wide variety of computerized and network capable calendaring software applications are available to assist in activity management. Within a closed, private network managed by a common server, products such as Microsoft Outlook® allow for integration of messaging, meeting schedules, and automated notification of schedule changes. Such systems work well in a constrained environment where all activity participants are coupled to the same server, and all activity participants frequently use the shared system to access notifications and schedule changes. However, these tools do not work well over open and disparate networks such as the Internet and the public telephone network to schedule events and/or notify participants of schedule changes.

For example, a variety of email systems provide limited delivery confirmation that notify a message sender when a message has been opened and presumably read by the recipient so long as the sender and recipient are coupled to the common mail server. However, delivery confirmation across the Internet and different mail applications is often impossible and is voluntary. Delivery confirmation has been limited to detection of whether a receiving device (e.g., a telephone or email inbox) has received the message. Because messages can be interrupted by voice mail or message systems, and email messages can be delivered to a mail box but left unopened, these prior systems do not actually confirm that the message has been communicated to the intended recipient.

Another limitation of conventional email notification systems is that they only work within email systems and are therefore unable to send notifications to phones, pagers, alternate email addresses, or other communication channels that are outside of the system. Hence, when a recipient is out of the office, an urgent email message cannot be retrieved and the notification will go unread. This is a particular problem in the type of notifications that are delivered for activity management in that the most critical notifications may occur at the last minute when a participant is traveling to an event location or otherwise disconnected from their office email or normal communication channel.

One tool that has developed in the field of notification across disparate communication networks is often referred to as “reverse 911”. Reverse 911 systems have been created to notify households and businesses within a particular geography of an emergency condition such as dangerous weather, criminal events, and the like. In these systems notifications are triggered by events, not calendared activities, and the notifications are not delivered to members of a group, but are instead delivered to an ad hoc collection of households defined by authorities assessing an emergency situation at hand.

The present invention recognizes that a tremendous amount of time is wasted pushing data and questions to members, and then following up, to confirm whether the information was received. Not only does the present invention automatically push messages by email or telephone, the present invention also uses various methods to confirm that the information has been accessed or received. The present invention also provides for a method of asking and automatically collecting and reporting answers to a question (i.e., polling).

The present invention is directed to removing the burden, currently shouldered by select members of an activity, of dispensing general data and time critical information to all or select groups within an activity. The present invention also addresses the need for tracking functions so that administrators can easily view which members have received messages and which have not.

### SUMMARY OF THE INVENTION

Briefly stated, the present invention involves services, systems and methods for managing, streamlining and tracking the communication between administrators and members of an organized group such as sports teams, scouts, church groups, PTA, clubs, business teams, board members and the like. The service is well suited for activities whose events are subject to change on a short notice, but is equally attractive to a wide range of events and activities that involve a fair amount of communication. Communication with activity members is managed as a combination of email, recorded and dynamically generated telephone messages, Instant Messaging and Short Message Service, as well as other available communication modes depending on the urgency of the information.

### BRIEF DESCRIPTION OF THE DRAWINGS

FIG. 1 shows main functions available from a home page implemented in accordance with the present invention;

FIG. 2 shows an exemplary user login process and an overview of the system functionality available to the user based upon their role;

FIG. 3 outlines processes in accordance with an implementation of the present invention and data collected when a new member sets up an account with a service in accordance with present invention;

FIG. 4 illustrates functionality available to a user with the role of Participant;

FIG. 5 illustrates functionality available to a user with the role of Limited Administrator;

FIG. 6 shows functionality available to a user with the role of Administrator;

FIG. 7 outlines functionality available to a user with the role of System Administrator;

FIG. 8 outlines a Partner management processes and data collected and stored related to each partner as well as processes and data related to promotion codes associated with each partner;

FIG. 9 illustrates processes and data associated with creating and managing an Activity within the present invention;

FIG. 10 shows processes associated with a user's event calendar related to activities;

FIG. 11 shows processes associated with the detailed activity view;

FIG. 12 illustrates an Activity Log that presents information about notifications and their status associated with a specific activity;

FIG. 13 shows several different types of notifications, data associated with each type and outlines processes related to the creation of notifications;

FIG. 14 shows the processes and data related to the creation methods and escalation logic associated with notifications identified as Alerts;

FIG. 15 shows processes, data collected and escalation related to the distribution of a recorded message to activities members via a calling mechanism for voice alerts;

FIG. 16 illustrates processes, data collected and details related to the system calling and interacting with a member via a telecommunication device;

FIG. 17 shows processes associated with the Activity member management system within the present invention;

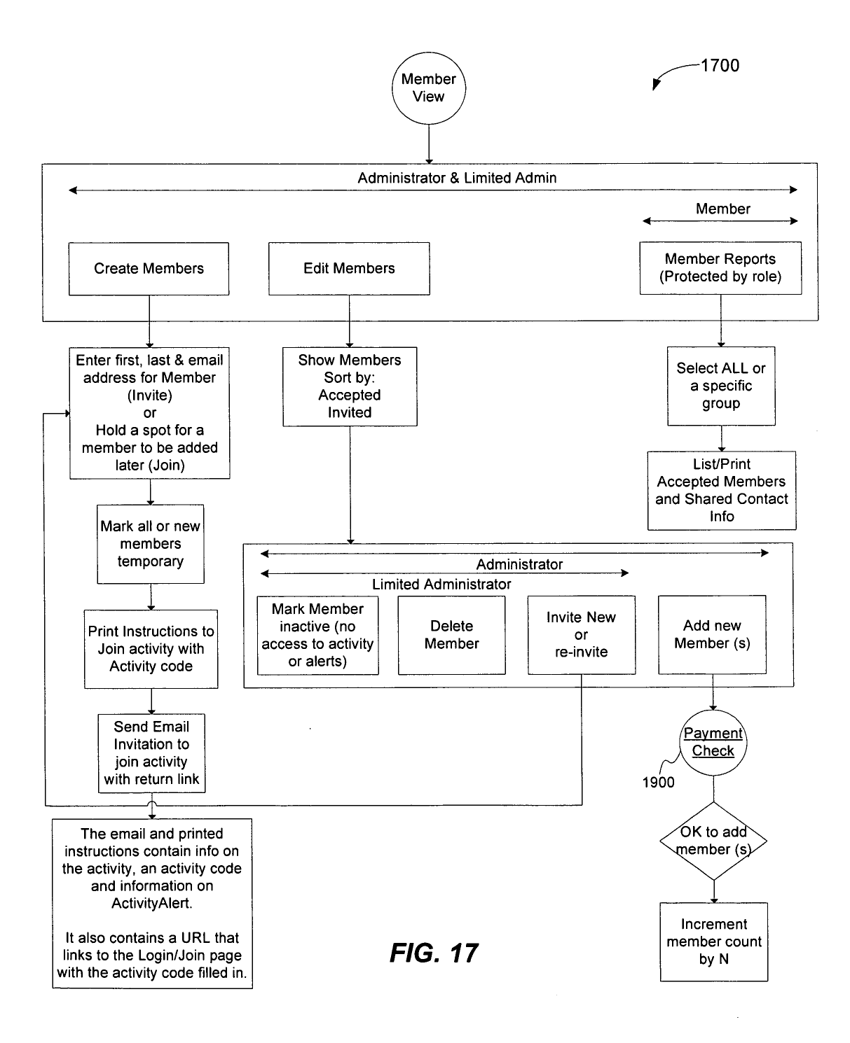

FIG. 18 illustrates processes and data associated with the Group management system for each activity; and

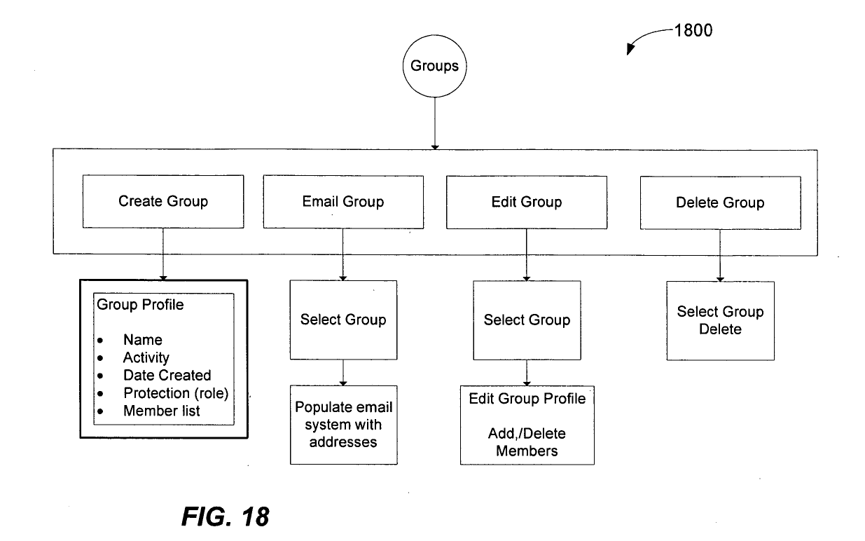

FIG. 19 shows processes and data associated with various payment systems that are associated with the present invention.

### DETAILED DESCRIPTION OF THE PREFERRED EMBODIMENTS

The present invention is illustrated and described in terms of services, systems and methods for managing, streamlining and tracking the communication between administrators and members of an organized group. Although the specific implementations often refer to delivery of time-sensitive messages related to activities of sports teams and leagues, the present invention is readily adapted to a wide variety of groups. These groups fall into many different categories and include; sports teams, scouts, church groups, parent teach organizations, clubs, business teams, board members and many others. The service is especially well suited for activities whose events are subject to change on a short notice, but is equally attractive to activities which require a fair amount of communication. Communication with activity members is managed as a combination of email, recorded and dynamically generated telephone messages depending on the urgency of the information, although the invention is readily adapted to any communication channels and modes that are used by the group members, including Instant Messaging, Short Message Service, pagers, written communication, facsimile, portable electronic messaging devices and the like.

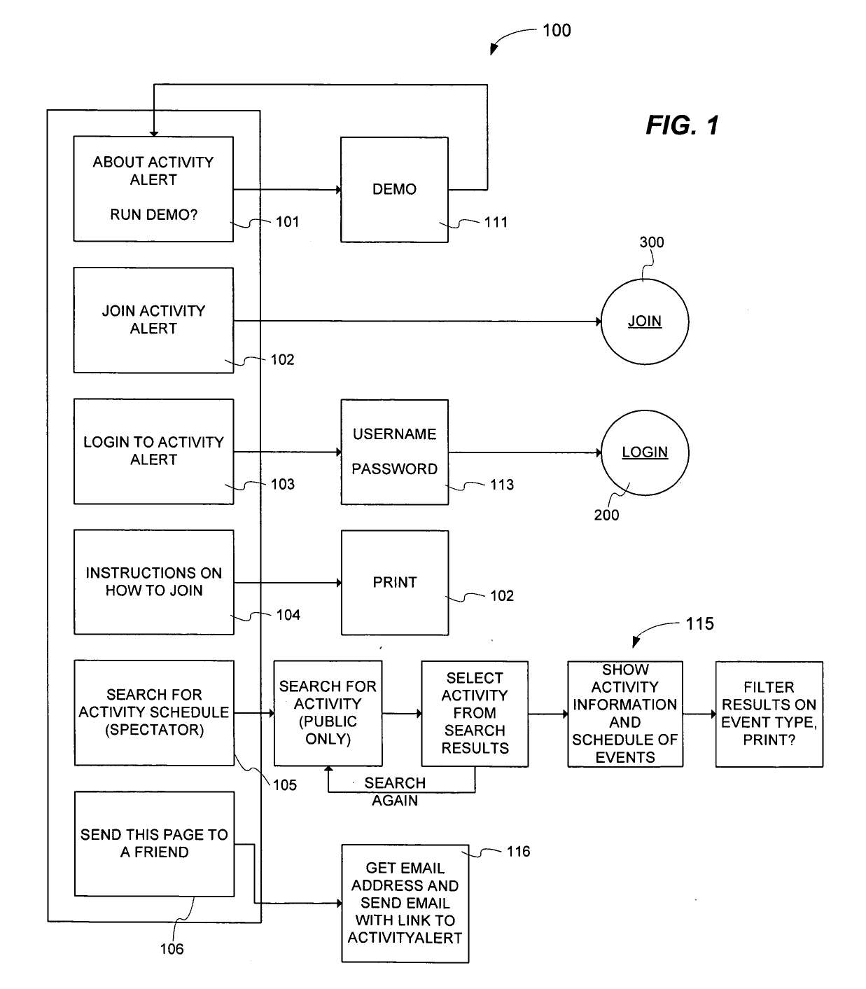

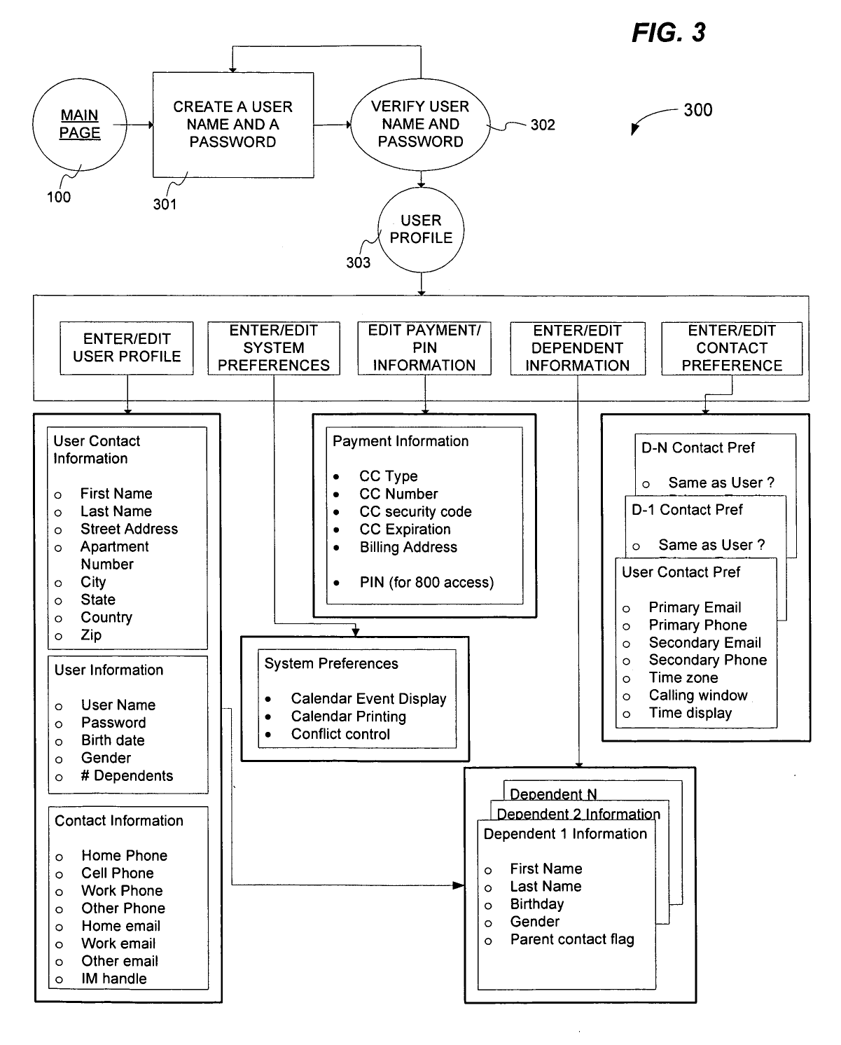

FIG. 1 shows main functions available from a home page or main page 100 implementing an embodiment in accordance with the present invention. Main page 100 presents information to a viewer together with a number of controls that allow the user to navigate to other pages that provide specific kinds of information, functionality and additional navigational controls. Process 101, for example, implements a user-selectable control that launches a user demonstration process 111. Processes 106 implements a user-selectable control that launches processes 116 to notify others about the system. Process 102 implements a user-selectable control that links to a join web page 300 (shown in FIG. 3) that, in turn, allows a user to join the system. A variety of administrative, advertising, and similar process may be implanted through main page 100 to meet the needs of a particular application.

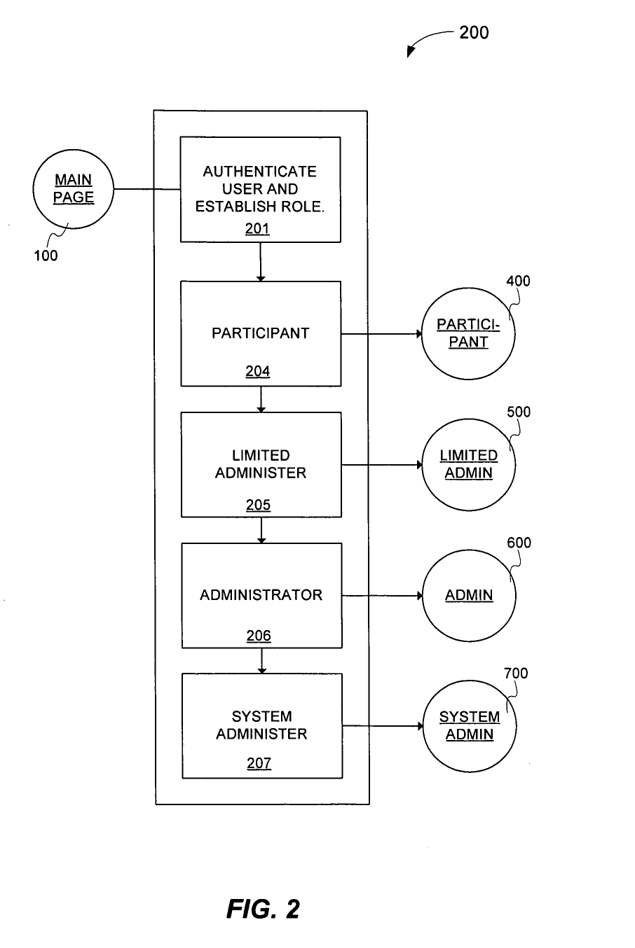

Login process 103 is intended for users that have already joined and launches credentials dialog 113 that gather information such as a user name and password, or other credentials used by the system to authenticate and/or identify a user. Once credentials are gathered processes 113 link a user to a login page 200 (shown in FIG. 2). Process 104 implements a user-selectable control that launches a display/print process 114 to display and/or print instructions about joining. Search process 105 implements a user-activated control intended for spectator use (i.e., users who have not logged in and/or may not have joined). In some instances it is beneficial to allow users in a role of spectator to have access to public activities and their schedule. Search process 105 launches processes 115 that allow a spectator to search and select particular activities, as well as display, filter and print information about the selected public activities.

Communication with activity members is managed as a combination of email, recorded and dynamically generated telephone messages depending on the urgency of the information. In a particular example, the present invention is implemented as a web service combined with telephony technology enabling the rapid delivery of dynamic information. When telephone communication is required, the present invention uses technology to dynamically create voice messages or record messages and route the calls through the lowest cost telephone switch (e.g., voice over IP).

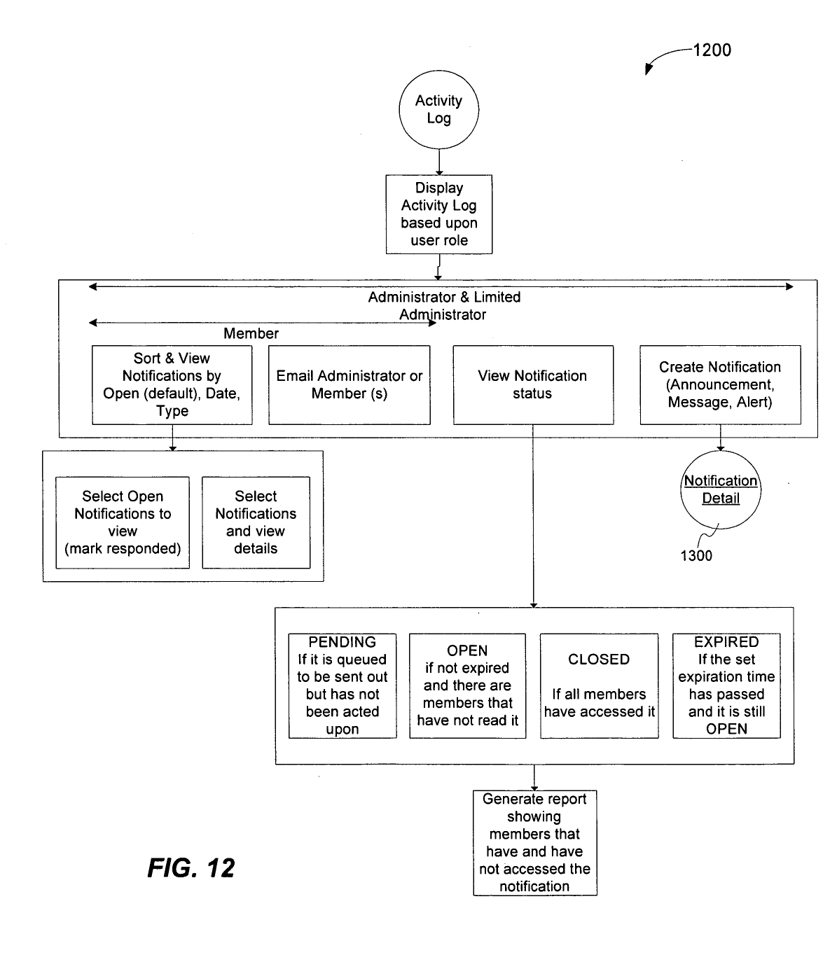

The present invention contemplates a community comprising three types of roles that users may be assigned: Administrators, Participants and Spectators. Administrators create and manage an activity, its associated membership list, communication with the members through an activity log (shown in FIG. 12) and various levels of notifications. The administrator is also responsible for paying for the fee-based components of the service. Participants join the service implemented by the present invention for free; create their profile and an associated profile for any dependents. The incentive for the participant is one time data entry, privacy, no hassle email and voice messaging and a unique calendar function. The calendar function merges the participant's activities, if any, with all dependents activities providing a unified view of all schedules. This merged calendar view shows any scheduled conflicts, provides links to mapping software for location and directions and is constantly updated with any schedule changes posted by an activities administrator. Spectators do not have an account, but may search public activities and view their schedule, maps and get directions. Users may be assigned more than one role for a particular activity and the users' roles may change over time as an activity progresses.

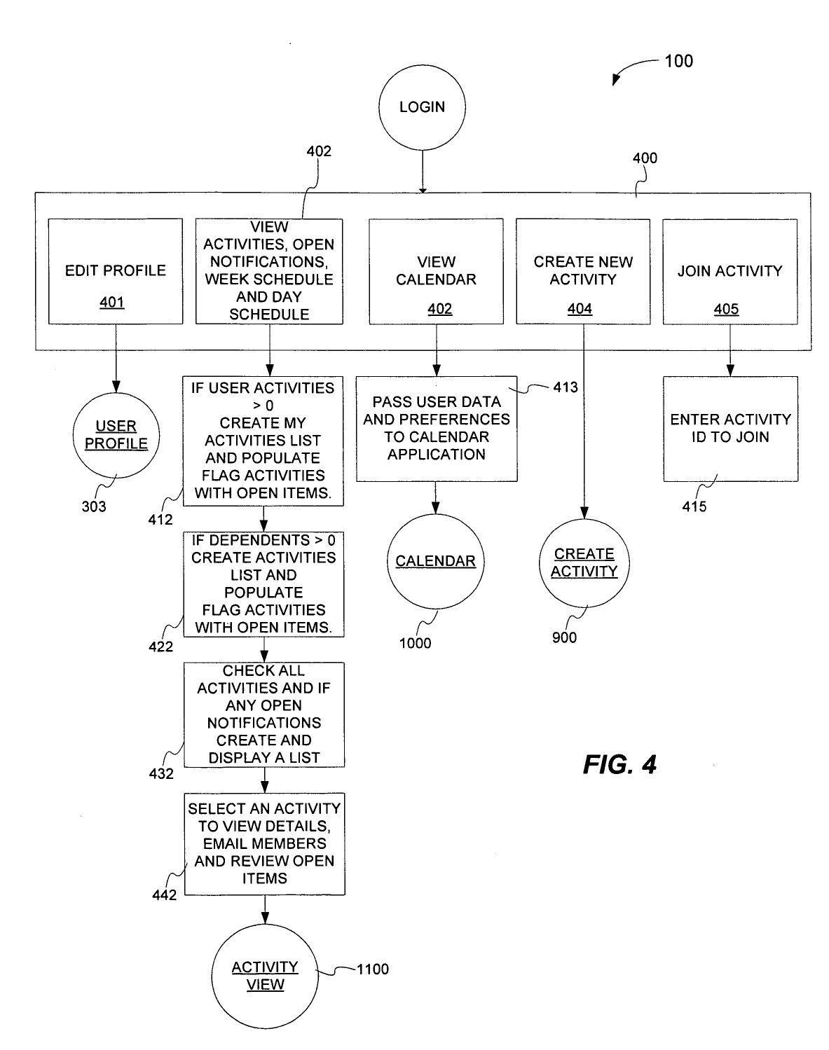

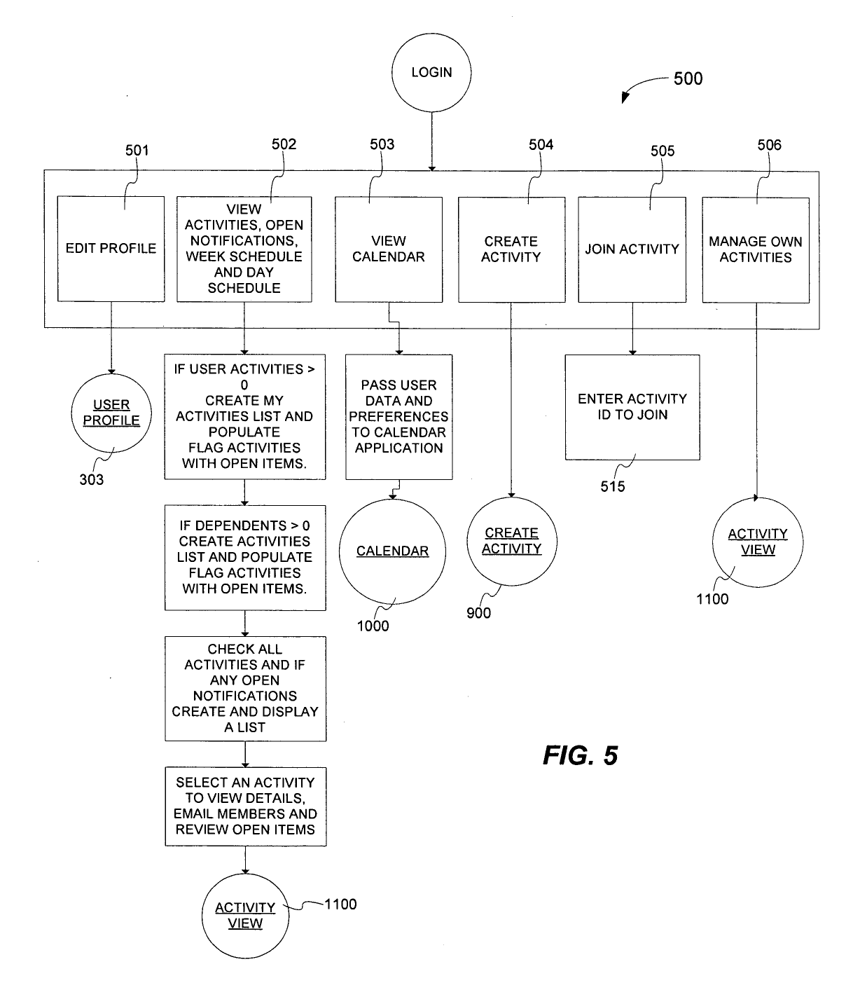

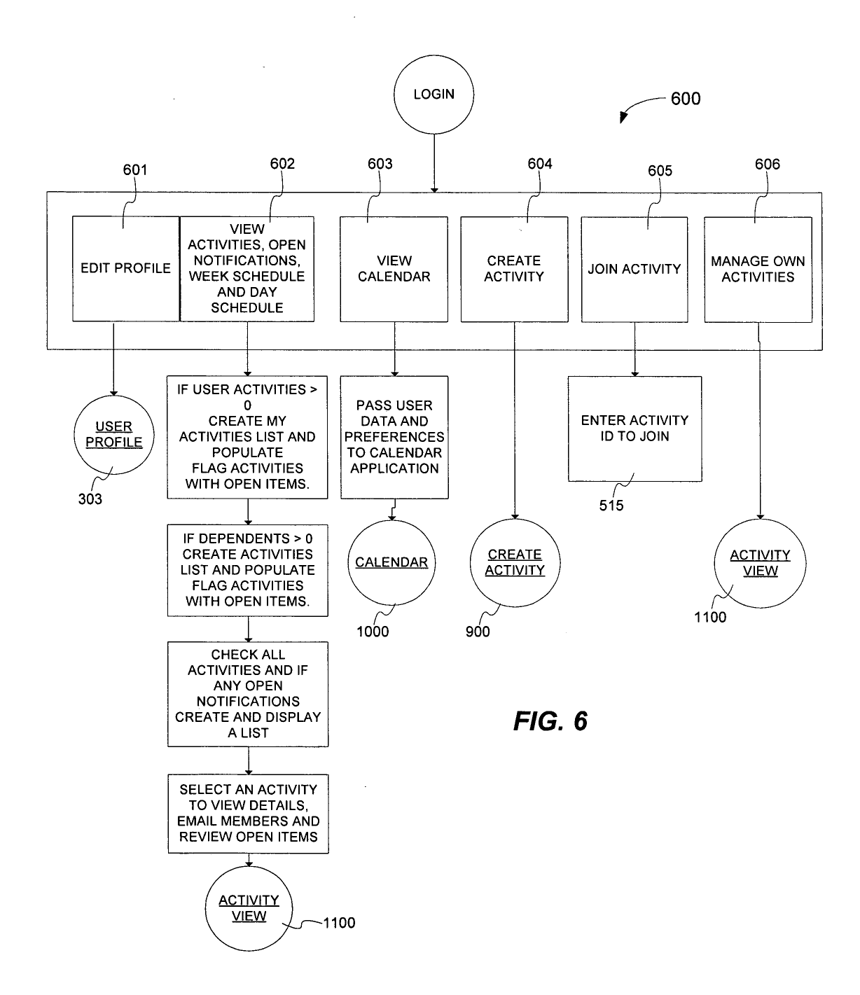

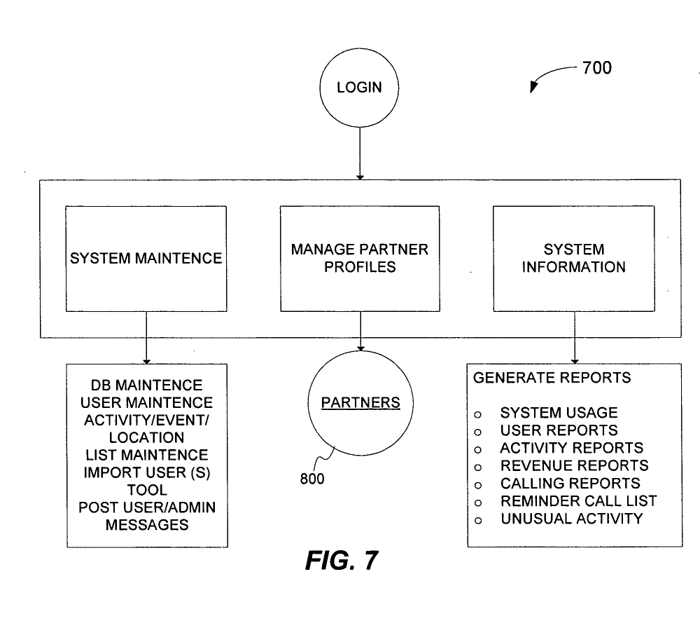

FIG. 2 shows an exemplary user login process 200 linked to from main page 100 shown in FIG. 1 as well as an overview of the system functionality available to the user based upon their role. Authentication processes 201 receive the user's credentials and authenticate the user to establish the user's identity and assigned role. Some remedial action may be taken upon failure to authenticate, for example, directing the user to instructions on joining. Based on the user's established role, login processes initiate role-specific processes 204 (participant role), 205 (limited administer), 206 (administrator) or 207 (system administrator). Each of the role-specific processes link to role-specific pages 400 (shown in FIG. 4), 500 (shown in FIG. 5), 600 (shown in FIG. 6) or 700 (shown in FIG. 7), respectively.

FIG. 3 outlines processes in an implementation of the present invention and data collected when a new member sets up an account with a service in accordance with present invention. In FIG. 3, bold-outlined boxes indicate examples of collected data. User credentials are established and verified in 301/302. A base or blank user profile is created in processes 303 An existing user may enter at process 303 to review an edit their profile. A user profile web page may be presented including user-selectable controls that allow the user to enter/edit profile information, enter/edit system preferences, enter/edit payment information, enter/edit dependent information, enter/edit contact preference information, or other user profile operations. The user selectable controls launch processes that present user interface controls such as dialog boxes for displaying and editing user contact information records, payment information records, system preference records, dependent information, and one or more contact preference records and the like.

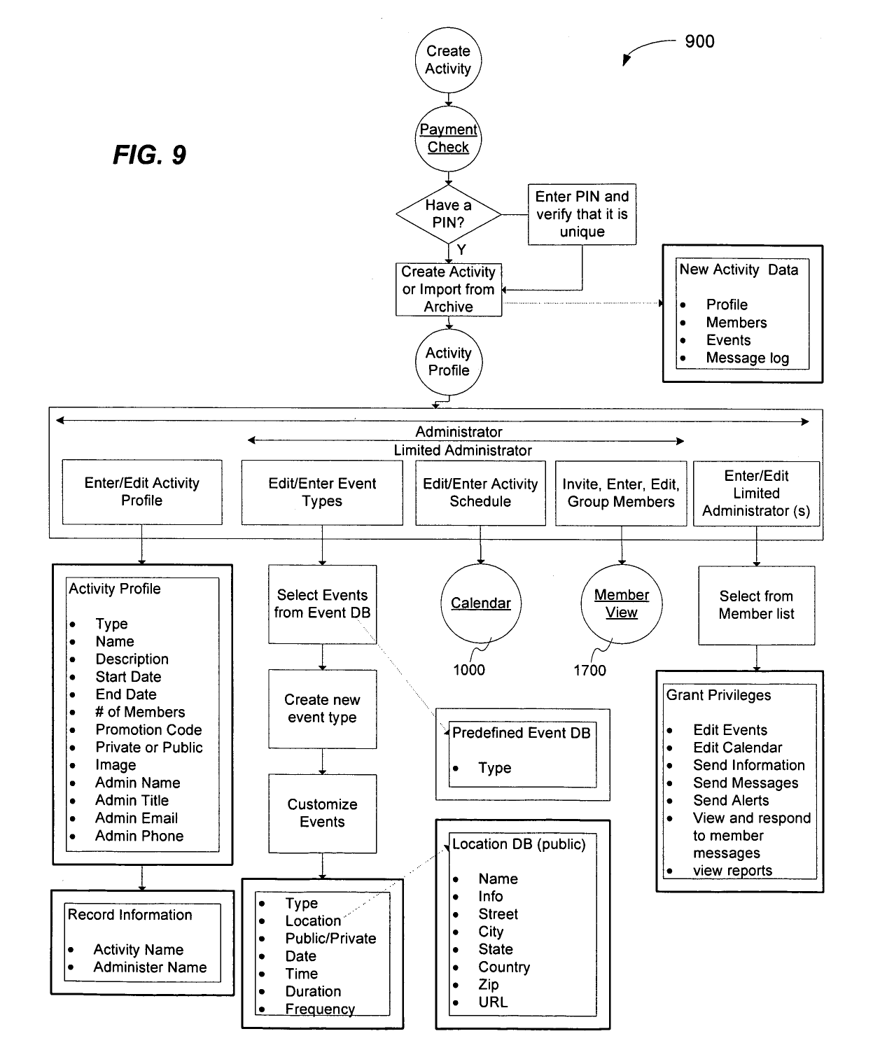

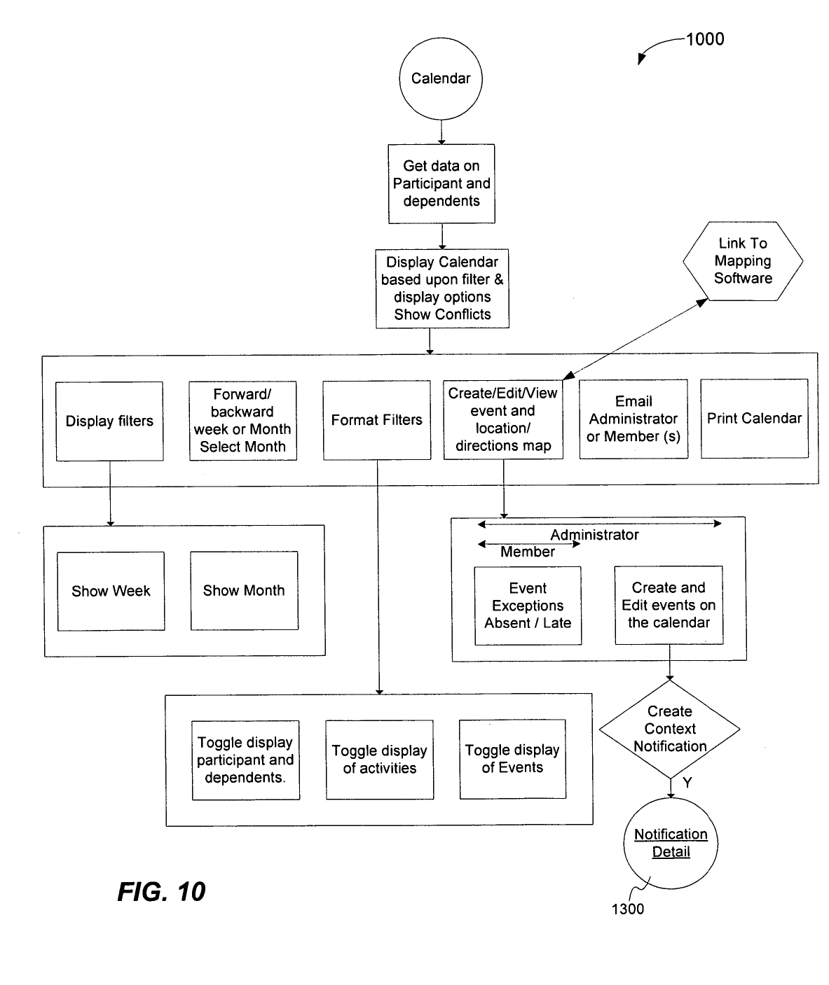

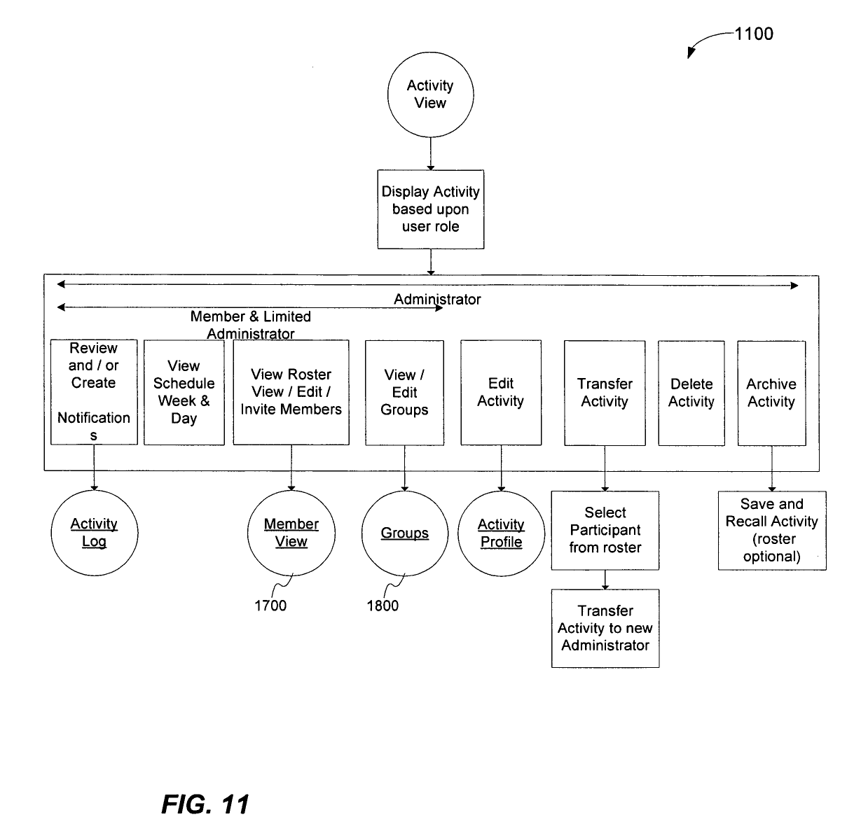

FIG. 4 illustrates functionality available to a user with the role of Participant. In the example of FIG. 4, a participant web page 400 is presented that presents information including user-selectable controls 401-405 that initiate an exemplary set of processes as indicated in FIG. 4. Processes 402, for example allow a user to view their activities, open notifications and the like. Actions 412, 422, 432 and 442 are performed to create and/or populate activities lists for a particular user and their dependents, and to display open notifications associated with those activities. When a user selects a particular activity in 442 the system links to an activity view page 1100 shown in greater detail in FIG. 11. Other exemplary actions include viewing a calendar that links to a calendar page 1000 shown in FIG. 10, creating a new activity which links to create activity page 900 shown in FIG. 9, and joining an existing activity that launches processes 415 that operate to associate the user with an existing activity.

FIG. 5 illustrates functionality available to a user with the role of Limited Administrator. The limited administrator role shown in FIG. 5 and the administrator role in FIG. 6 include processes 506/606 that allow activity management.

FIG. 7 outlines functionality available to a user with the role of System Administrator. A system administrator is responsible for background tasks such as database maintenance, software upgrades, user maintenance and the like. In the particular implementation web pages such as shown in FIG. 7 are implemented to direct and assist in activities performed by a system administrator.

Email Confirmation Mechanism

When a message is sent via email the recipient receives an email that contains a header indicating that there is a message for them and containing a link (e.g., a uniform resource locator or “URL”) to press or paste into a web browser to access the message content. In implementations of the present invention this link or URL also contains information that uniquely identifies the recipient. This information is included, for example, by including parameters in the URL. When the user clicks on the URL, this identifier is transmitted to the web software, which then displays the appropriate message and logs that the user has accessed the information. The automatically generated web page may also contain buttons that the user may push to respond to a question that requires a formatted or constrained response such as a yes/no/I don't know answer. These buttons are not limited to yes/no/I don't know responses and may display any information, which a user may select between various predefined options.

A second method of verifying receipt of an email is to embed a zero size HTML object in the email that contains a link and the associated user identification information. When the email is opened, in an HTML compliant window, the link is resolved and the “hit” on the website is recorded to indicate that the user has received the message. This method may also embed buttons, which generate hits to indicate the recipient's selection.

Telephone Confirmation Mechanism

The present invention supports two types of voice message generation. The first may be initiated from the web site and will either automatically generate a message from a list of predefined events or call the activity administrator and record a voice message. The second method is when the activity administrator calls an automated system that lets them log in via a PIN, select an activity and optionally a predefined subgroup and then record a message to be automatically distributed. In both cases, the recorded message is converted to a WAV file and stored on the system. Before any calling is initiated an email message is sent to the activity or subgroup members via the system defined above. Rather than a written message, the users may play the WAV file to listen to the message and its receipt is confirmed.

After a set period of time has elapsed, the system checks to determine which members of the activity or subgroup have not received the message. The system accesses a phone preference list for the users for which message receipt is not confirmed, and calls the first number for each user. When the first number called is busy, the system will call back after waiting a defined amount of time. When the phone is answered the system will play an introduction listing the activity name and sender and instruct the user to press a particular dial pad key or combination of keys (e.g., press the “#” key for a general message or enter your PIN for a private message) to indicate receipt and begin the message playback. Once the message has been played the system will either disconnect or instruct the recipient to press a particular dial pad key or combination of keys to answer the question if indicated (e.g., press the “1”, “2” or “3” key to answer yes/no/I don't know to the question in the message). These keys are not limited to yes/no/I don't know responses and may indicate any information, which a user may select between various predefined options.

When no receipt is received, the system will check the user's profile and determine whether an alternative number is indicated it will wait a set time interval and then try that phone number. The process of attempting alternative communication modes and/or escalating the message delivery attempt repeat until the user responds or all alternative communication modes have been tried. When a user has still not been reached, the system will wait a predetermined amount of time and then start the calling sequence over again. This will continue until the user is reached or the message has expired or the system has completed a predetermined number of iterations of the above process. Once all iterations are completed the system will try the main number one more time, if the receipt key sequence is not detected and the message is not private, it will play the message twice attempting to leave it on a recording device such as a voice mail or answering machine. In some cases it may be desirable to attempt multiple communication modes in parallel rather than serially.

One significant feature of the present invention is that participants' contact information, such as email and phone numbers may be kept private. In a particular implementation, each participant creates a contact list which contains primary and secondary email address(es), and phone numbers. The entire list or select entries may be marked private. The present invention uses this list to send messages, but if an email or phone number is marked private the information is never shared. This feature ensures that users can feel comfortable entering contact points that are most likely to reach them in a timely manner, like a cell number, and that the information remains private.

The present invention presents all information via the web using an activity log. Information, including recorded messages, is stored in the log. When a member of the activity receives an email from the system in accordance with present invention the email will preferably only contain the activity name, sender and a hyperlink (URL) back to the log entry. The link also contains a unique identifier that identifies the member. When they click on the link and access the information, the system “knows” who it is and can mark the information received by that member. This data enables the system to track “who has accessed what” and to generate reports for the administrator of the activity. The use of the log also ensures that the user population is continually returning to the web site where demographically significant advertising can be presented.

A major goal for implementations of the present invention is for the web site to be easy to navigate and to simplify the creation of an activity. With this in mind the system has been designed to learn about locations, new activities and the associated events. The goal is to create a large database of locations, activities and taxonomy for events that are in the terminology and context of the activity. As the system learns about new activities and events, it will make the creation of similar activities that much easier for the users.

Activities

FIG. 9 illustrates processes 900 and data associated with creating and managing an Activity within the present invention. Activities may be any organized event such as a team, club, board of directors, etc. The creation and management of scheduled events and communication related to activities is a primary service implemented by the present invention. A user creates an activity and becomes the activity administrator or assigns the role of activity administrator to another user. The activity has a name, a season (start date and end date) and a set number of members. Detailed activity information can be viewed on a role-specific basis according to the processes shown in FIG. 11.

The administrator then creates the activity schedule by adding events to an online calendar managed by the system. The administrator now invites members to join the activity. This invitation may be sent by email or the administrator may print out invitations to be handed out. The members then join the service, accept (opt in) the invitation, and become members of the activity. Once a member of an activity the activity schedule automatically appears in the members calendar and the registered member will receive notifications associated with the activity. Users that have been invited via email will also receive all emailed notifications but will not have access to the online schedule nor will they receive any telephone-based notifications.

Events

All activities have a schedule that is managed by the administrator. Placing events on the activities calendar creates the schedule. FIG. 10 shows processes associated with the event calendar related to activities. Events are items such as a meeting, game, party etc., which have a date, time and sometimes a location. Events may repeat at a defined frequency such as a practice, which occurs every Monday and Wednesday at 4:00 for the entire season.

Notifications

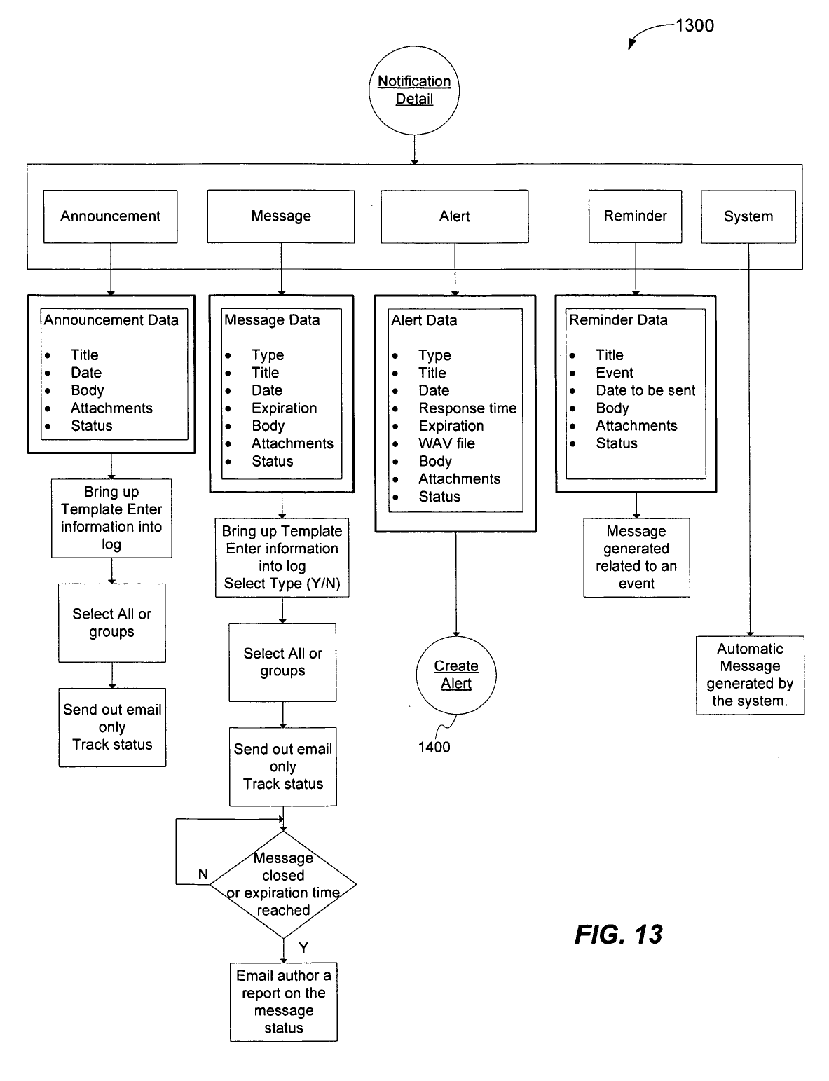

Notifications comprise information that is to be shared with members of an activity. The information may be text, attached documents or a WAV file (recording). A notification is classified as to the importance and timeliness of delivery. Processes involved in managing notifications are show in greater detail in FIG. 13. In the implementation of FIG. 13 there are four types of notifications defined in a particular implementation of the present invention: reminder, announcement, message and alert. A fifth type of notification, system notifications, are for administrative purposes and not necessary for an understanding of the present invention.

Reminders are notifications that are automatically sent out at a set time before a specific event. The administrator sets the reminder time and message in advance. Reminders do not require a response and it is not critical that all members receive it. Reminders are only distributed by email. An example is an email notification that is sent 24 hours before a scheduled game to remind members to arrive half an hour early for team pictures.

Announcements are notifications that are distributed to the members that do not require a response and it is not critical that all members receive it. Announcements will only be distributed by email. Examples are discount tickets are available for a particular event, sharing a relevant investment article and sending out a vacation schedule.

Messages are notifications that are distributed to all members of an activity and have a timeline associated. Typically a message would be sent out days in advance by email and activity members would have plenty of time to access the information. One important characteristic is that a message may be elevated to an Alert for those members who have not accessed the information. This elevation will occur at a time set by the administrator before the message expires. An example is a conference call schedule or a form that must be filled out and returned by a specific date.

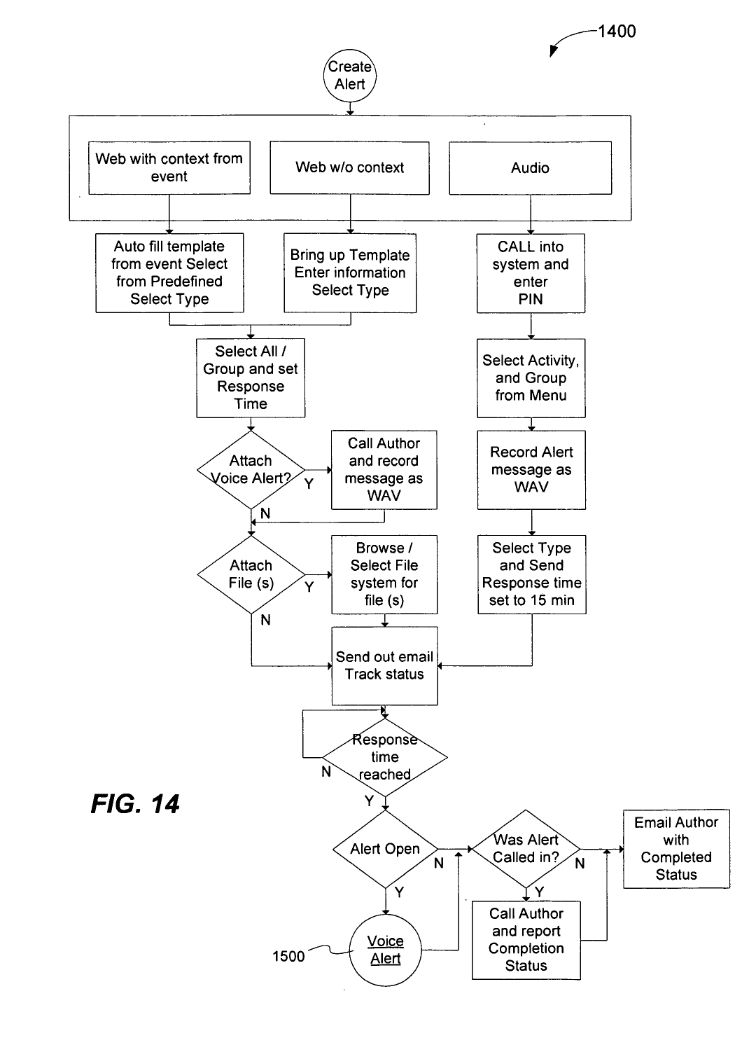

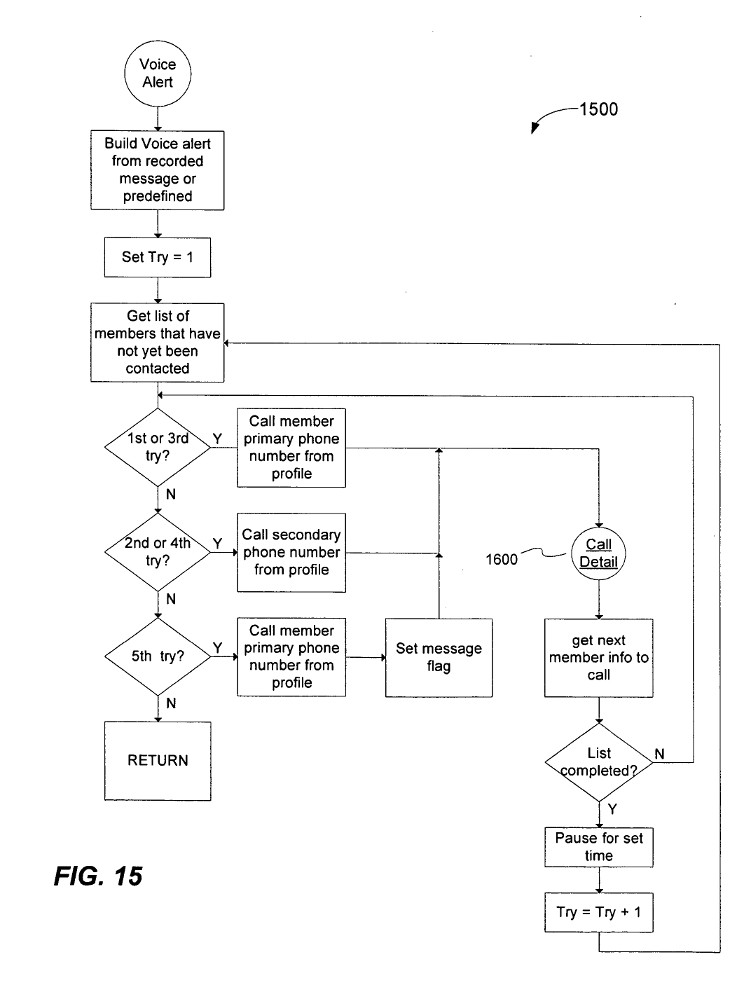

Alerts are notifications that must be distributed to the members immediately. FIG. 14 shows the processes and data related to the creation methods and escalation logic associated with notifications identified as Alerts. In the particular implementation, alerts are first distributed by email to give online members a chance to respond. Any member that has not responded within the set time (as short as 5 minutes) will receive a call. FIG. 15 shows processes, data collected and escalation related to the distribution of a recorded message to activities members via a calling mechanism for voice alerts. Alert audio messages may be limited to under a minute and the member must acknowledge receipt by pressing a phone key before the message is played. The administrator using a toll free number and a PIN may send recorded alerts. An example situation in which the alert functionality is useful is when a practice or game that has been cancelled shortly before the scheduled time.

### EXAMPLE 1

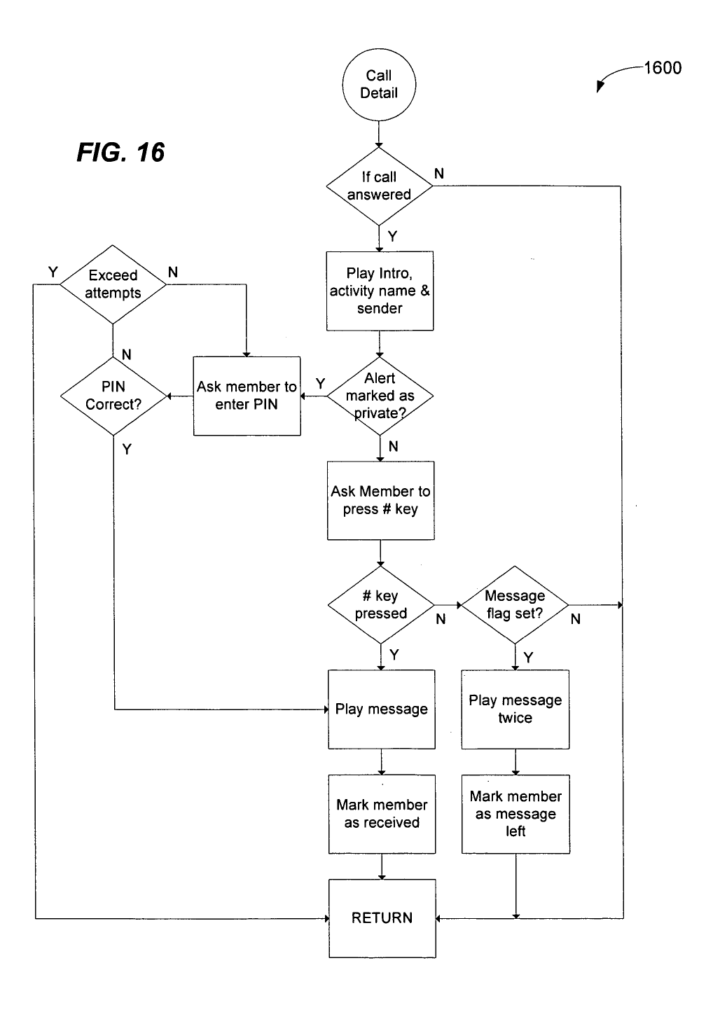

A busy parent, after picking up the kids at school she has 1½ hours before a softball game and plans to pick up dinner at the grocery store. It is a 30-minute drive to the field. At about the same time, the coach is informed that maintenance at the field has taken longer than planned and the game must be rescheduled. He immediately logs into the service in accordance with present invention, creates an alert canceling the game, and a time sensitive email is sent out. In the next 15 minutes, half the team has viewed the message. The Alert is now converted to a voice message and calls are placed to the remaining members. As illustrated in FIG. 16, a call is placed to the family home, the answering machine picks up but there is no message-received confirmation. The system then escalates the message delivery function to use a cell phone number for the parent. When the cell phone rings, she answers and listens to the alert introduction, presses a key (e.g., the “#” key or other dial pad key) to confirm receipt the system plays the message and hangs up. The parent can then rest easy knowing this is a private number and she can finish up her chores without rushing off to a canceled game. Half an hour after the alert is sent out the coach can verify that every member of the team has received the message and does not need to wait at the field to tell every arriving participant.

### EXAMPLE 2

While on a sales call, a software professional has agreed to create a customized version of a product on an accelerated development schedule. This may be the companies largest sale to date, but would alter the current business and development plan. While driving back to the airport the sales professional places a call or sends and email message to the system in accordance with the present invention, enters his PIN, and posts a message requesting a conference call with his board the next morning at 10:00 am. An email is automatically sent to the board members containing a link to play back the message and a yes or no check box is presented. Two of the board members are also traveling and receive calls on their private cell phones. The present invention plays the introduction and waits for the confirmation key to be pressed, once pressed it plays the message and the member is requested to press 1 for yes and 2 for no. By the time the sales professional returns home and logs into his account he/she can see that 5 of the 6 members are available for the call. He posts a message in the Activity log to confirm that the call is scheduled for 10:00 am and provides the call specifics.

Features contemplated for inclusion in a specific implementation include:

Assigning a default maximum run time for activities. Activities will run for a maximum of 6 months, but may be extended. This is a housekeeping measure that is readily adapted to the needs of a particular activity management application.

Payment Models

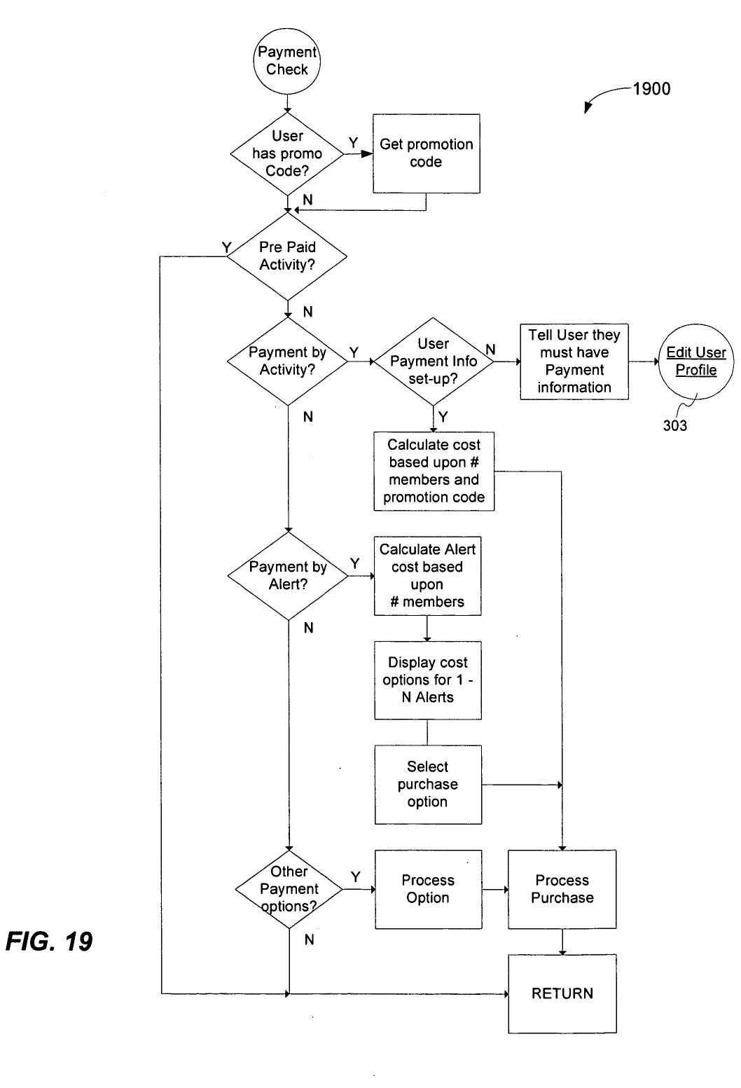

In a payment model shown in FIG. 19 payment collection will occur two times for each activity. The first payment will be charged on the start date of the activity and will be based upon the number of members who have accepted their invitation or joined by the start date. The second payment will be made on the end date of the Activity and is based upon any new members added since the start date. An email will be sent to the administrator outlining the second payment and giving them the option to continue the activity for another 6 months.

A second payment mechanism will only charge for the use of the calling system. There will be no change for the creation of an activity and the use of the scheduling, member management and email notification with tracking. To use the calling features the activity administrator will be required to pre-purchase alerts which are defined as one full cycle of calling all members of the activity. These alerts will be based upon the number of members in the activity. In addition to the purchase of individual alerts users will be offered a ‘season pass’ that enables unlimited calling for the activities defined season.

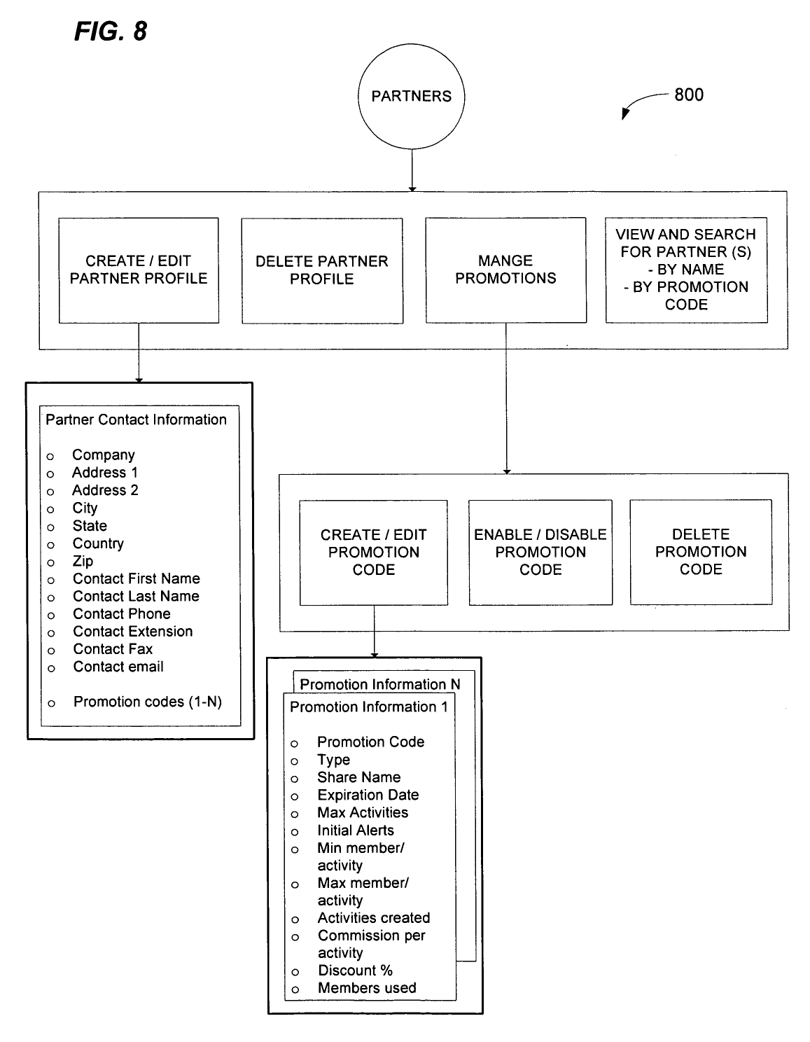

When a new activity is created the system may mail/email a card with the toll free number and the PIN associated with that activity. In addition, the mailer may include a set number of reference cards that may be given away to third parties or partners. These cards could be linked to a unique number and used for promotions. FIG. 8 outlines a partner management processes and data collected and stored related to each partner as well as processes and data related to promotion codes associated with each partner.

Extensions and Additional Features

The present invention provides an activity/event management system that is readily adapted and extended to include a variety of additional features. These include:
Recording a team name and administrator by the system calling them.
When a voice alert is activated the system calls back the initiating party when all members have indicated receipt.
The present invention can be implemented with a mechanism to transfer an activity to a new Administrator.
The present invention implements a mechanism for a member to share their schedule with another member.
The present invention enables users place reminders on their calendar. This reminder is a special type of activity that has no messaging or they could join and send messages to themselves—in other words, reminder calls.
It is also contemplated that another type of special activity may be created by the system itself to perform system administration, such as capability to call users that have not logged in and have a set number of messages to review. This is not an alert, but simply a reminder phone call to check their account.
The present invention enables a set of common pre-recorded or “canned” voice alerts for common alert messages such as when and event is cancelled, postponed, moved or changed. FIG. 15 shows processes, data collected and escalation related to the distribution of a recorded message to activities members via a calling mechanism for voice alerts.
The present invention contemplates sharing an activities schedule with another activity.
The present invention supports a mechanism by which activity members may communicate to the activity administrator their attendance to a specific or series of events.
The present invention supports a promotion code mechanism illustrated in FIG. 8 that supports the offering of discounts on or prepaid activities. This system can be used to support sales incentives and sponsorship of activities.
The present invention contemplates supporting the creation of a league or other overseeing group that may contain different teams or activities that share a common schedule or other item that brings the activities together under a common administrator.

### CONCLUSION

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A method of managing communication with a group, the method comprising:
defining members of the group;
creating a message to the group members;
storing the message in a member-accessible repository;
for each group member, generating a notification identifying the member;
individually communicating the notification to each member, wherein the notification prompts the member who receives the notification to retrieve the message from the member-accessible repository; and
confirming delivery of the notification on a member-by-member basis by tracking when each member retrieves the message from the member-accessible repository.

2. The method of claim 1 wherein the act of defining members of the group comprises storing at least one contact information record comprising information selected from the group consisting of: electronic mail address, telephone number, physical address, instant message identifier, and pager contact information for each member.

3. The method of claim 1 wherein the act of defining members of the group comprises storing at least two contact information records comprising information selected from the group consisting of: electronic mail address, telephone number, physical address, instant message identifier, and pager contact information.

4. The method of claim 1 further comprising tracking each notification to detect when a notification has not been effectively delivered.

5. The method of claim 1 wherein the notification indicates that a message has been created, but the notification does not include all the message content.

6. The method of claim 1 wherein the act of communicating the notification to a particular member uses a first communication mode and a first contact information record specified for the particular member.

7. The method of claim 1 wherein the act of communicating the notifications to each member further comprises:
communicating a first notification to a first member using a first communication mode; and
communicating a second notification to a second member using a second communication mode different from the first communication mode.

8. The method of claim 1 further comprising:
upon determining that a notification to a particular member has not been effectively delivered, sending a subsequent notification to the particular member using alternative contact information.

9. The method of claim 1 further comprising:
upon determining that a message has not been delivered to a particular member, sending a subsequent notification to the particular member using alternative contact information.

10. The method of claim 1 wherein the group members comprise participants, administrators, spectators, assistants, and other persons involved in a particular activity.

11. The method of claim 1 further comprising: providing a message center comprising:
resources for receiving, storing, and sending messages to and from the members;
resources for sending notifications to and from the members; and
resources for tracking and confirming delivery of notifications and messages.

12. The method of claim 11 wherein the repository is implemented as a web site and the members can retrieve the message by accessing the web site.

13. The method of claim 12 wherein the web site is shared by a plurality of groups and implements authentication procedures so that messages intended for a particular group are accessible only to authenticated members of that group.

14. The method of claim 11 wherein the repository is implemented as a voice mail system and the act of storing the message in the member-accessible repository comprises calling the voice message system.

15. The method of claim 1 wherein the act of communication the notification comprises sending an email a member and the act of confirming delivery comprises:
prompting the member in the notification to click on a uniform resource locator (URL) link; and
confirming delivery when the repository is accessed using the URL link.

16. The method of claim 15 wherein the notification prompts the member to select amongst two or more options and the notification comprises buttons that the user may selectively activate to indicate a selection.

17. The method of claim 1 wherein the act of communicating the notification comprises calling a member using a telephone connection and the act of confirming delivery comprises:
prompting the member in the notification to press one or more numeric keys to generate tones on the telephone connection; and
confirming delivery when the generated tones are detected.

18. The method of claim 1 wherein the notification prompts the member to select amongst two or more options by pressing specific ones of the numeric keys.

19. A communication system implementing the method of claim 1.

20. A communication system comprising:
a message center having resources for receiving and storing messages for a particular group of members;
a data structure within the message center for storing membership records for one or more groups, the membership records defining contact information for each member;
a notification system operable to identify members of the particular group that have not received a message stored for the particular group and to communicate a notification to the identified members; and
a message delivery system responsive to a request by a particular member to deliver a stored message to that particular member.

21. The communication system of claim 20 wherein the message delivery system tracks which members have successfully received the stored message and informs the notification system.

22. The communication system of claim 21 wherein the notification system is operable to send multiple notifications to a particular member using the defined contact information for that particular member.

19. The communication system of claim 22 wherein each notification is associated with an expiration time, and the communication system is operable to send a subsequent notification upon expiration of a prior notification.

23. The communication system of claim 20 wherein the message center is implemented as a web site and the members can retrieve the message by accessing the web site.

24. The communication system of claim 23 wherein the web site is shared by a plurality of groups and implements authentication procedures so that messages intended for a particular group are accessible only to authenticated members of that group.

25. The communication system of claim 16 wherein the repository is implemented as a voice mail system and the members can retrieve the message by calling the voice message system.

26. The communication system of claim 16 wherein the repository has to access member contact information and can email, call, and/or instant message the member with the message.
